(19) United States
(12) Patent Application Publication
(10) Pub. No.: US 2016/0068424 A1
(43) Pub. Date: Mar. 10, 2016

(54) DEVICE AND METHOD FOR CUTTING THROUGH WORKPIECES OF MECHANICALLY BRITTLE AND NON-METALLIC MOVING AT A SPEED

(71) Applicant: Schott AG, Mainz (DE)

(72) Inventors: Carsten Renz, Eschershausen (DE); Constantin Braemer, Holzminden (DE); Matthias Jotz, Alfeld (Leine) (DE)

(21) Appl. No.: 14/847,138

(22) Filed: Sep. 8, 2015

(30) Foreign Application Priority Data
Sep. 8, 2014 (DE) 10 2014 013 262.5

(51) Int. Cl. C03B 33/10

(52) U.S. Cl. CPC C03B 33/107

(57) ABSTRACT

A device for cutting through workpieces of mechanically brittle and non-metallic material moving at a speed along a separation line after scoring is provided. The device includes a tool holder that is rotatable about an axis of rotation. The tool holder accommodates at least one cutting wire as a cutting tool to introduce a surface rupture or a crack into the workpiece. The cutting wire is disposed in the tool holder in such a manner that the surface rupture or the crack is introduced substantially perpendicular to a feed direction of the workpiece moving at a speed.

### CROSS REFERENCE TO RELATED APPLICATIONS

This application claims benefit under 35 U.S.C. § 119(a) of German Patent Application No. 10 2014 013 2625 filed Sep. 8, 2014, the entire contents of which are incorporated herein by reference.

### BACKGROUND OF THE INVENTION

1. Field of the Invention

The invention relates to a device and method for cutting through workpieces of mechanically brittle and non-metallic materials such as glass ribbon, in particular ultrathin glass ribbon by low-splinter or low-chip and precise scoring.

2. Description of Related Art

The standard method for cutting or cutting through workpieces of non-metallic and in particular brittle materials is “scoring and breaking”. In this case, a scoring acting as a predetermined breaking point is produced in the surface of the workpiece by means of a scoring tool and the workpiece is then broken mechanically by bending. The disadvantages of this method lie in particular in the breaking, since the break on the one hand is not very controllable as a result of its high speed, and on the other hand during bending, in general substantially more elastic energy is stored by the workpiece than is required to produce the cut edge. This excess energy can result in uncontrolled fracturing with, for example, splintering or conchoidal fracturing of the cut edge. Furthermore, as a result of the bending, on the side of the plate-shaped workpiece facing away from the scoring a compressive stress zone is formed into which the fracture necessarily enters. The fracture front in this case usually turns around out from the cut edge. The consequence is an irregular cut edge with conchoidal fracturing and lance cracks and a strong tendency to splintering.

In the standard methods in the glass industry, the scorings serving as predetermined breaking points are produced by means of hard bodies such as diamonds or hard metal wheels. Alternatively to this, according to DE 35 37 434 A1, DE 43 00 730 C1, DE 42 14 159 C1 and DE 1 971 661 6C2 predetermined breaking points can be produced in glass bodies by means of laser beams.

The Unexamined Laid-Open Patent Application DE 197 15 537 and the Patent Application EP 08 72 303 A2 describe methods and devices for cutting through flat plate-shaped workpieces of mechanically brittle and brittle material by means of a symmetrical heat radiation spot which has an increased radiation intensity in its edge zone and is moved along a predefined separation line and the moving separation line section is then cooled. This method is suitable in principle for low-splintering cutting of brittle material, but is complex. A method for cracking off glass articles in which a plurality of laser jets are used has become known from WO 98/56722. The European Patent Application EP 08 39 597 A1 describes a method and the design of devices suitable for this for cutting strip-shaped workpieces of brittle material. In this case, a pulsed point heat source is directed onto the workpiece and as a result of the thermomechanical stresses thus formed, a crack separating the workpiece is “drawn” along a predefinable cut edge. The patent application EP 09 03 327 A2 describes a method for cutting non-metallic workpieces in which a plate-shaped workpiece is heated on the underside by a linear heating element and at the same time is cooled on the upper side by blowing with a coolant.

A device and a method for cutting through have become known from EP 1 768 935 B1, in which separation lines are introduced into a workpiece with the aid of bending vibrations, which lead to complete cutting through of the workpiece.

DE 12 63 997 discloses a rotating wheel on which brushes act. Not disclosed in DE 12 63 997 is a workpiece moving at a speed but rather a fixed glass object on which a rotating wheel with brushes is acting.

Furthermore DE 12 63 997 discloses a grinding tool for grinding a weakening zone, where the grinding tool is softer than glass. The device according to the invention on the other hand, comprises a cutting tool which differs in principle from a grinding tool.

### SUMMARY

A disadvantage with the previously known methods is that the tools with the cutting must be synchronized to the feed rate of the moving workpieces of mechanically brittle and non-metallic materials. If a glass ribbon is produced continuously, a synchronization of the scoring tool is required. At feed rates of more than 0.5 m/min up to 50 m/min, in particular 3 m/min to 38 m/min, it is not possible to use standard methods for the scoring/cutting in ultrathin glass production without major expenditure as far as the synchronization is concerned for example. In the prior art, hard bodies such as, for example, hard metal wheels were used as cutting edges. As described previously, the positioning of the hard metal wheels must be very precise in the cutting direction since otherwise the wear on the tool cutting edges is too high. A further disadvantage was that the cutting takes place transversely to the feed direction of the glass ribbon and the cutting speeds required for this at the high feed rates of the glass ribbon of 0.5 m/min up to 50 m/min could not be achieved in order to achieve an adequate cutting quality. Furthermore, there is a very high risk of glass fracture if a rupture is to be introduced into the glass surface without synchronizing the cutting tool.

It is therefore the object of the invention to obviate the disadvantages of the prior art and provide a cutting device which allows a cutting of workpieces made of mechanically brittle and non-metallic materials which are moved at a feed rate and in a feed direction. The device should furthermore allow a low-splinter cutting. Furthermore, the scoring should be accomplished by simple means and at a sufficient speed. In particular, the cutting should be reliably possible even at high feed rates of the glass ribbon in the range of 0.5 m/min to 50 m/min.

According to the invention, this object is solved whereby in a device for cutting through workpieces of a mechanically brittle and non-metallic material moving at a feed rate and in a feed direction, a tool holder is provided, where the tool holder is rotatable about an axis of rotation and the tool holder according to the invention accommodates at least one cutting wire as cutting tool for introducing a surface rupture or a crack into the workpiece, where the cutting wire is disposed in the tool holders in such a manner that the surface rupture or the crack is introduced substantially perpendicular to a feed direction of the workpiece moved at a speed. The advantage of a cutting wire as cutting tool which is moved with a rotation movement and which has a defined length can be seen in that as a result of the rotational movement with a defined length and a defined force as well as a defined speed and a defined delivery, a linear surface rupture can be produced so that it is possible to introduce a break into the moving workpiece. A synchronization as in the prior art is not necessary. As a result of the configuration of the cutting tool in the form of a cutting wire, the difference speed of the surface to be ruptured in the transverse direction can be compensated as a result of its flexibility. DE 12 63 997 known from the prior art with a fixed object on which a rotating wheel with brushes acts does not show the problem of tracking and adaptation. It has been found to the credit of the inventors that the use of a cutting wire has a great deal of flexibility in such a manner that such a synchronization is not necessary. Such a tool can in particular be used in processes which, as a result of very high conveying speeds in the range of up to 50 m/min in the production process, require a very short deployment time of asynchronous cutting movements transverse to the conveying direction. Whereas in the prior art it was necessary to increase the force transverse to the cutting edge of the scoring tool, for example, the cutting wheel, continuously as a result of the feed of the glass ribbon, with the use of a cutting wire as cutting tool according to the invention, the force can remain almost constant since the cutting wire is deflected in the direction of feed of the glass ribbon due to its flexibility. By this means any damage to the tool cutting edge is largely avoided so that the cutting tool need not be synchronized in the feed direction.

In an advanced embodiment of the invention it is provided that the cutting wire is provided with a coating. In a particularly preferred embodiment, this is, for example, one or a plurality of crystals which are applied to a cutting wire and form a tool with many indeterminate cutting edges which are almost independent of the cutting movement of the tool in the movement of the material to be processed.

The method according to the invention comprises the following steps:

Firstly, an initial crack is introduced with the aid of a cutting tool into at least one side of the plate-shaped workpiece, where the cutting tool comprises a tool holder which rotates about an axis of rotation and the surface rupture or the crack is introduced into the workpiece by a cutting wire accommodated in the tool holder. Following this, the workpiece is completely cut through, in particular by fracture, along the surface rupture or the crack. However, the crack or scoring only has a length of up to 25 mm. The fracture contour is then produced by superposition of the internal stress of the glass ribbon, i.e., in contrast to the prior art, no cut is produced over the entire length but only a short crack. The fracture of the glass ribbon is then accomplished by introducing mechanical stresses.

The method described above is characterized in that as a result of the design of the cutting tool as a wire tool in the form of a cutting wire, it is so flexible that difference speeds of the surface to be ruptured in the transverse direction to the cutting direction need not be prevented by synchronization. The introduction of the surface rupture or the crack or the scoring by means of a wire tool produces only a short linear surface rupture of up to 25 mm and thus enables reproducible damage in position and shape. In particular, the method can be used in manufacturing processes of glass which is moved at high feed rates, in particular conveying speeds, preferably in manufacturing processes of thin and ultrathin glass having thicknesses of less than 1 mm, preferably less than 0.5 mm, preferably in the range of 5 μm to 350 μm. Since the cutting wire is coated in an undefined manner, a plurality of cutting edges can be applied which then also result in a plurality of surface ruptures. The plurality of surface ruptures lie so close to one another so that they can be seen as a scoring.

The feed rate in a drawing process used as a manufacturing process such as a draw-down process for the workpiece to be cut in the form of a glass ribbon is more than 0.5 m/min, in particular lies in the range of 0.5 m/min to 50 m/min, preferably in the range of 3 m/min to 38 m/min.

It is particularly preferred if the surface rupture or the crack is introduced by the rotating cutting wire with a defined length, a defined force and a defined speed during drawing over the surface of the workpiece, in particular, the glass ribbon. The length of the surface rupture or the crack lies in the range of more than 0 mm, preferably in the range of 5 to 25 mm, particularly preferably in the range of 10 to 15 mm. The rotational speed of the cutting tool in the form of the cutting wire lies in the range of more than 5 rpm to 3500 rpm, preferably 100 rpm to 100 rpm, particularly preferably 170 rpm to 300 rpm.

In a further developed embodiment, it is provided that the workpiece is moved along a feed direction with the predefined feed rate. Preferably the surface rupture or the crack is introduced with the rotating cutting wire substantially perpendicular to the feed direction, that is in the transverse direction.

The thin glass ribbon comprises, for example, D263. D263 eco, AF 32, AF 32 eco, Mempax, B270T from Schott AG, Mainz. Other thin glasses are also possible.

In addition to the method, the invention also provides a use of the method and specifically for cutting glass ribbons, in particularly ultrathin glass ribbons, substantially transversely to the conveying direction of the ultrathin glass ribbon. Accordingly, the invention also comprises a device for cutting to length a glass ribbon, in particular a thin glass ribbon or ultrathin glass ribbon, comprising a cutting device according to the invention with a cutting wire as cutting tool.

### BRIEF DESCRIPTION OF THE DRAWINGS

The invention will be described hereinafter with reference to the figures as an example for restriction hereto.

FIG. 1a-1b shows a view of a cutting tool according to the invention and a brittle object to be cut;

FIG. 2a-2b shows the introduction of scoring in the border region of a glass ribbon according to the prior art (FIG. 2a) and according to the invention (FIG. 2b).

FIG. 3a-3b shows a device for producing a glass ribbon with a tool according to the invention.

### DETAILED DESCRIPTION

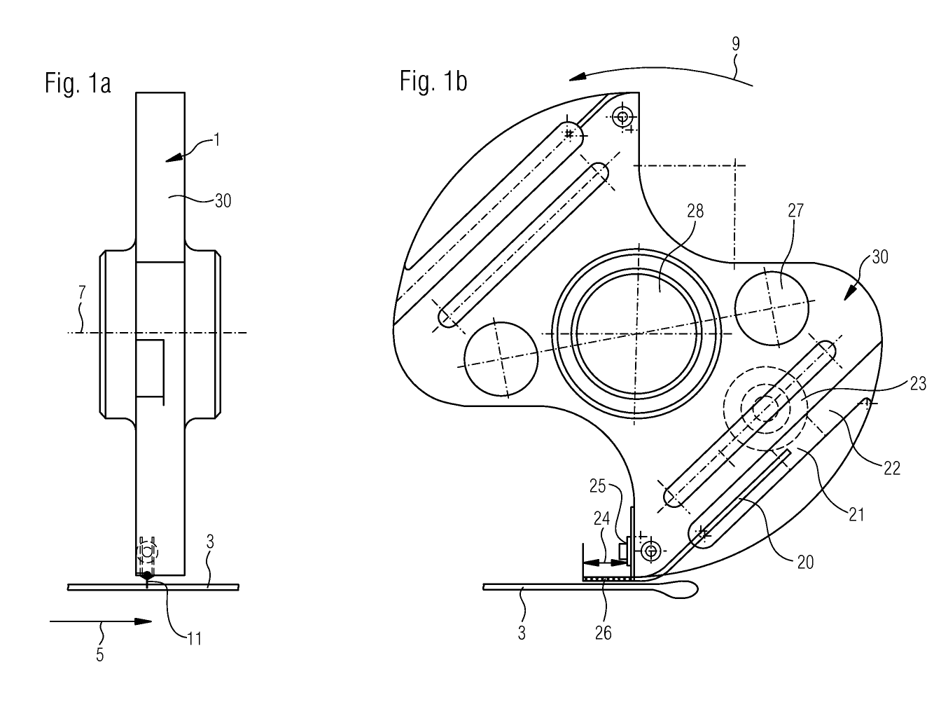

FIGS. 1a-1b show a device 1 according to the invention for scoring or introducing a crack or scoring into a workpiece 3 moving at a speed, which is moved in a direction 5. The tool holder 30 is rotatable about an axis of rotation 7 in the direction of rotation 9. The rotational speed can be up to 3500 revolutions per minute in this case.

The direction of rotation 9 can be turned as required.

The separation line, which is to be cut transversely to the feed direction 5 of the moving brittle object, here the glass plate 3, is designated with 11 in the plan view in Fig. la on the device according to the invention.

The at least one cutting wire according to the invention, which is predominantly coated with crystals is designated with 20.

Figures la to lb show different views of the tool holder 30 in the form of a rotating disk. Thus, Fig. lb shows a side view of the tool holder 30 and the glass ribbon 3 as well as the clamped cutting wire 20 which is inserted with a wire holder 21 in the guide groove 22 provided for this purpose and which is fixed in its position by means of the clamping element 23. As a result of this arrangement, it is possible that the cutting wire 20 can be varied both in the length of the overhang 24 and can be aligned by the wire tensioner 25 in the tangential run-out to the circumference of the tool holder 30. The cutting wire 20 is preferably coated with diamond 26. A plurality of undefined cutting edges can be used for separating the glass ribbon 3 since the coating with diamonds 26 encloses the cutting wire 20 over 360°. A defined rotation of the wire holder 21 makes it possible to use the cutting wire 20 in several positions. This has the result that if the diamond coating 26 is worn, the tool can be replaced rapidly.

In order to save weight, openings 27 are introduced into the tool holder 30.

The clamping element holder 28 is used for connection to a motor-driven axis. The axis can, for example, be driven by means of an electric motor so that the tool holder 30 with cutting wire 20 rotates at a speed of 5 rpm to 3500 rpm. The preferred rotational speed lies in the range of 170 rpm to 300 rpm.

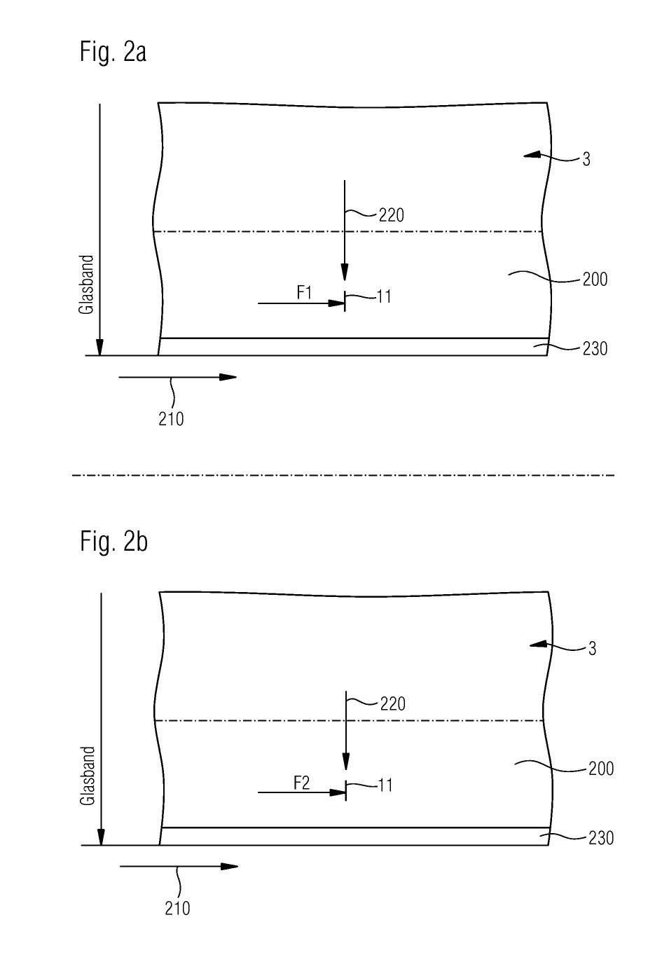

FIGS. 2a to 2b show the introduction of a scoring or crack or scarification in the border region of a glass ribbon using a tool according to the prior art (FIG. 2a) and using a cutting wire (FIG. 2b).

In the prior art (FIG. 2a), the introduction of a scoring or scarification 11 in the border region 200 of a glass ribbon using a cutting wheel (not shown) is depicted. For this purpose a force F1 is introduced in direction 210 transverse to the cutting edge of the scoring tool which is aligned in scoring direction 220. This force is increased continuously during engagement of the tool due to the feed of the glass ribbon 3 in direction 210 and damages this. The border of the glass ribbon is designated with 230. FIG. 2b shows the introduction of a scoring 11 with a cutting wire (not shown) according to the invention.

In FIG. 2b the force F2 remains almost constant since the cutting wire is deflected as a result of its flexibility in the direction of the feed 210 of the glass ribbon 3. By this means any damage to the tool cutting edge is reduced or largely avoided so that the cutting tool need not be synchronized in direction 210. In FIG. 2b as in FIG. 2a the border region is designated by 200, the border by 230 and the scoring direction by 220.

FIGS. 2a to 2b only show the introduction of a starting scoring or scarification by the cutting tool. Only the surface rupture is produced by the introduction of the starting scoring. The final breaking is accomplished by bending and the associated superposition of internal stresses.

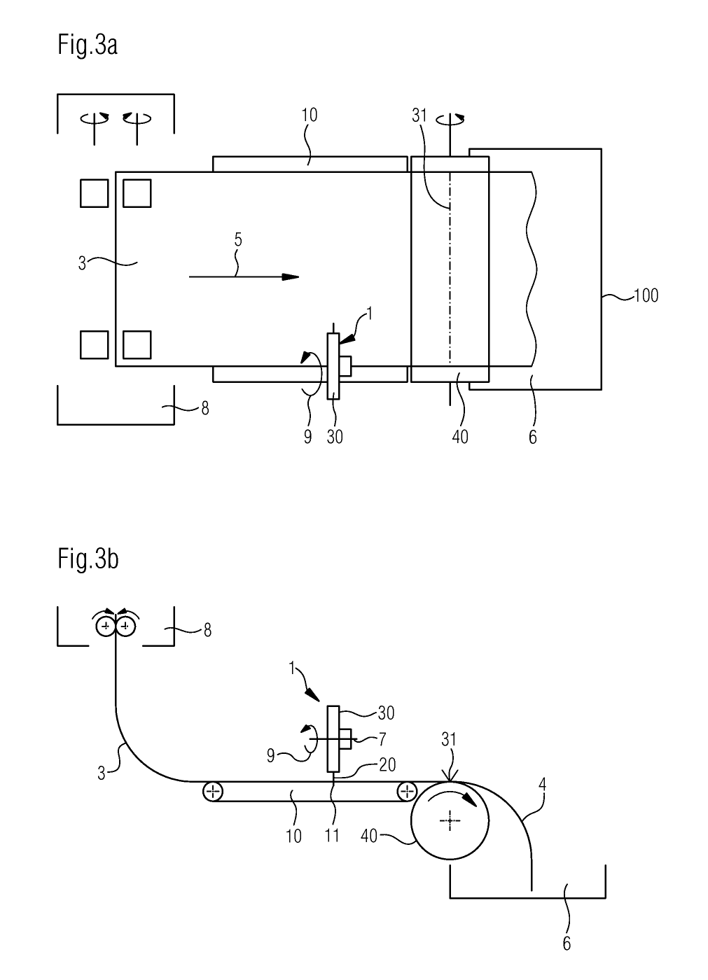

FIG. 3a and FIG. 3b show a device 1 according to the invention with a rotating tool holder 30 which rotates about the axis 7 in direction 9 and a cutting wire 20. FIG. 3a shows the glass ribbon with the device 1 according to the invention in plan view. FIG. 3b shows the arrangement of the device 1 within the framework of the manufacturing process of the glass ribbon, in particular the ultrathin glass ribbon. With the aid of the cutting wire 20, it is possible to introduce a scoring 11 in the glass ribbon 3 transversely to the feed direction 5 so that the section 4 can be separated from the glass ribbon 3, for example, in a collecting container 6, as shown in FIG. 3b. The glass ribbon 3 comprises a glass ribbon drawn in the draw-down process which emerges from a drawing machine 8. The speed at which the glass ribbon 2 is drawn from the drawing machine 8 in direction 5 is more than 0.5 m/min and lies preferably in the range of 0.5 m/min to 50 m/min.

The thickness of the glass ribbon 3 is preferably in the range <1 mm, preferably <0.5 mm, preferably in the range of 5 μm to 250 μm, so that in the preferred case this comprises thin glass ribbon or ultrathin glass ribbon.

After deflection from the vertical into the horizontal onto a conveyor belt 10, the glass ribbon 3 is guided in the feed direction 5 below the tool holder 30 according to the invention which contains the cutting wire 20. After introducing the scoring or crack 11 into the surface of the glass ribbon 3 with a defined length of, for example, 5 mm to 25 mm, the glass ribbon 3 is deflected over a roller 40.

The stresses thereby produced can break the glass ribbon 3 on the separation line 31 due to superposition of the internal stress by the scoring, in particular starting scoring 11, introduced with the cutting wire 20. The sections 4 thereby produced can be collected in the collecting container 6. Furthermore, it is possible to use the glass ribbon 3 without using the tool holder 30 with the cutting wire 20 according to the invention in following parts of the installation 100 with continuing processes, e.g. winding. The configuration according to the invention is substantially used to finish and cut to length the glass ribbon at high feed rates. A cutting to length is necessary, for example, if the glass ribbon is rolled onto a roller, e.g. during a roll change or other transition phases in the manufacturing process. After the cutting to length has been accomplished, e.g. during a roll change, the cutting process is stopped and the glass ribbon is supplied to the subsequent process.

With the invention, a device and a method is provided for the first time which enables a scoring of a glass ribbon without requiring a synchronization. Furthermore, the wear of the cutting tool caused by the lateral loads during feeding and cutting in the transverse direction is largely eliminated.

Therefore, the present disclosure includes: Device for cutting through workpieces of mechanically brittle and non-metallic material moving at a speed along a separation line after scoring comprising a tool holder (30), wherein the tool holder (30) is rotatable about an axis of rotation (32), characterized in that the tool holder (30) accommodates at least one cutting wire (20) as cutting tool for introducing a surface rupture or a crack into the workpiece, wherein the cutting wire is disposed in the tool holder in such a manner that the surface rupture or the crack is introduced substantially perpendicular to a feed direction of the workpiece moving at a speed.

The device is characterized in that the cutting wire (20) comprises a coating, where the coating comprises one or a plurality of crystals.

The device is characterized in that the cutting wire has a length and the length lies in the range of 5 to 25 mm.

A method for scoring and subsequent cutting through of workpieces of mechanically brittle and non-metallic materials which are moved along at a speed, comprising the following steps: introducing a surface rupture or a crack (11) with the aid of a cutting tool into at least one side of the workpiece, characterized in that the cutting tool comprises a tool holder (30) which is rotated about an axis of rotation (32), and the surface rupture or the crack (11) is introduced into the workpiece by a cutting wire (2) accommodated by the tool holder substantially perpendicular to the feed direction of the workpiece which is moved at a speed; along the surface rupture or the crack (11) of the workpiece, this is completely cut through by superposing an internal stress of the workpiece.

The method is characterized in that the surface rupture or the crack (11) is linear.

The method is characterized in that the surface rupture or the scoring (11) is introduced by the rotating cutting wire with a length in the range of 5 mm to 25 mm during drawing over the surface of the workpiece.

The method is characterized in that the workpiece is moved along a feed direction (5) at a feed rate and the surface rupture or the crack (11) is introduced with the rotating cutting wire at a rotational speed of 5 rpm to 3500 rpm perpendicular to the feed direction (5).

The method is characterized in that the workpiece is a glass ribbon which is moved at a feed rate in the range of 0.5 m/min to 50 m/min.

The method can move the workpieces at a feed rate in the range of 0.5 m/min to 50 m/min along a feed direction (5) with respect to the feed direction.

The method and device can produce a glass ribbon.

What is claimed is:

1. A device for cutting through workpieces of mechanically brittle and non-metallic material moving at a speed along a separation line after scoring, comprising:
a tool holder that is rotatable about an axis of rotation, the tool holder having at least one cutting wire as cutting tool for introducing a surface rupture or a crack into the workpieces,
wherein the cutting wire is disposed in the tool holder in such a manner that the surface rupture or the crack is introduced substantially perpendicular to a feed direction of the workpieces.

2. The device according to claim 1, wherein the cutting wire comprises a coating, where the coating comprises one or a plurality of crystals.

3. The device according to claim 1, wherein the cutting wire has a length and the length lies in the range of 5 to 25 mm.

4. A method for scoring and subsequent cutting through of workpieces of mechanically brittle and non-metallic materials which are moved along at a speed, the method comprising:
introducing a surface rupture or a crack with the aid of a cutting tool into at least one side of the workpiece, the cutting tool comprising a tool holder that is rotated about an axis of rotation, and the surface rupture or the crack is introduced into the workpiece by a cutting wire accommodated by the tool holder substantially perpendicular to a feed direction of the workpiece; and
superposing an internal stress on the workpiece along the surface rupture or the crack to completely cut through the workpiece.

5. The method according to claim 4, wherein the surface rupture or the crack is linear.

6. The method according to claim 4, wherein the surface rupture or crack is introduced by the rotating cutting wire with a length in the range of 5 mm to 25 mm during drawing over the surface of the workpiece.

7. The method according to claim 4, wherein the workpiece is moved along the feed direction at a feed rate and the surface rupture or the crack is introduced with the rotating cutting wire at a rotational speed of 5 rpm to 3500 rpm perpendicular to the feed direction.

8. The method according to claim 4, wherein the workpiece is a glass ribbon which is moved at a feed rate in the range of 0.5 m/min to 50 m/min.
